(19) United States
(12) Patent Application Publication
(10) Pub. No.: US 2007/0038381 A1
(43) Pub. Date: Feb. 15, 2007

(54) Efficient method for alignment of a polypeptide query against a collection of polypeptide subjects

(76) Inventors: Timothy Allan Melchior, Colorado Springs, CO (US); Diane Lynn Zand, Colorado Springs, CO (US)

Correspondence Address: TIMOTHY A. MELCHIOR, 3417 MOUNTAINSIDE DRIVE, COLORADO SPRINGS, CO, 80918, US

(21) Appl. No.: 11/161,606

(22) Filed: Aug. 9, 2005

(51) Int. Cl. G06F 19/00

(52) U.S. Cl. 702/19

(57) ABSTRACT

The invention relates to a method that efficiently identifies segments of a collection of polypeptides which are similar to a query polypeptide. Candidate alignments of all or part of the query polypeptide with similar amino acid sequences from the collection of polypeptides are first identified using a scalable parallel processing filter algorithm. The candidate alignments are further examined to yield an ordered list of scored alignments. This method enables massive parallel processing with minimized logic requirements and maximized logic utilization to achieve a dramatic reduction in the time required to produce a high quality sequence alignment report with a fraction of the hardware resources required by current methods.

### BACKGROUND

Polypeptides consist of sequences of amino acids. Proteins and protein fragments are polypeptides. The terms “polypeptide” and “amino acid sequence” are used interchangeably herein to refer to a polymer of amino acid residues. Identifying similarities between polypeptides is essential for understanding DNA and its relationship to the characteristics of organisms, diseases, and therapies. Similarities between polypeptides are observed by aligning a typically short query polypeptide with one or more typically longer subject polypeptides.

The terms “alignment” and “sequence alignment” are used interchangeably herein to refer to the correlation of two polypeptides in a manner that indicates similarity between the polypeptides. Alignments are graphically displayed in a number of ways. One approach used by the National Center for Biotechnology Information (NCBI) is shown in FIG. 23.

The term “gap” is used herein to refer to the insertion of one or more amino acid “holding place” within either the query or subject polypeptide. A gapped alignment of two polypeptides is one which demonstrates similarity between the query and subject polypeptides after gaps have been inserted into one or both of them.

Although over 100 amino acids are found in nature, sequence alignments are nearly always limited to aligning polypeptides consisting of the 20 genetically coded amino acids and three special cases. Twenty-three unique letters have been assigned to these 23 alternatives for ease of reference. These letters and the amino acids they represent are shown in FIG. 24.

One of the three special cases is denoted by the letter “B” which is used when an ambiguity exists between the amino acids represented by the letters “N” and “D”. The second special case is denoted by the letter “Z” which is used when an ambiguity exists between the amino acids represented by the letters “Q” and “E”. The final special case uses the letter “X” to denote an undetermined amino acid.

The term “similarity matrix” is used herein to refer to a table which correlates a list of amino acids against the same list, scoring the degree of similarity between each amino acid at each intersection point. In the preferred embodiment, a 23 by 23 matrix is used to show the similarity between the 23 commonly used amino acids. The two main families of similarity matrices are the BLOSUM and PAM families which are well know to those skilled in the art.

The terms “score” and “similarity score” are used interchangeably herein to refer to the score associated with a given pair of amino acids. Similarity between a pair of amino acids is determined by a similarity matrix which assigns a range of positive scores for relatively similar amino acids and a range of zero or negative scores for relatively dissimilar amino acids.

The insertion of gaps into the query and/or subject sequences accounts for missing or inserted amino acids that often exist in similar sequences. The term “open gap penalty” refers to the penalty that is deducted from the alignment score when a gap first appears in an alignment.

The term “gap extension penalty” refers to the penalty that is deducted from the alignment score for each subsequent adjacent amino acid gap in an alignment.

The term “gap penalty” refers collectively to the open gap penalty and the gap extension penalty.

A score of an alignment sequence, considering similarity scores and gap penalties, determines the alignment score which is a measure of the degree of similarity between the two sequences.

The term “alignment score” refers to the total running score ascribed to an alignment after summing the similarity scores and deducting the gap penalties.

The term “BLAST” refers to the Basic Local Alignment Search Tool, which is an industry standard algorithm for aligning sequences. Numerous versions of BLAST have been created by many entities, but all contain the common trait of indexing small segments of a sequence database and identifying likely alignments by observing the convergence of indexed segments when a query sequence is similarly segmented and its segments are looked-up in the index.

The term “FASTA” has two uses herein. The first refers to an algorithm much like BLAST based on the method of W. Pearson and D. Lipman [Proc. Natl. Acad. Sci. USA 85, 2444-2448 (1988)]. FASTA was the predecessor of BLAST and although it is slower than BLAST, it is a little more sensitive that BLAST and sometimes yields different results. For this reason, FASTA is still used today. The second use of the term “FASTA” is in reference to the FASTA format which is a sequence database file format used to store the input subject sequences for virtually all alignment tools.

The term “expect value” refers to a statistical measure given to an alignment. It describes the number of alignments with the same degree of similarity one can expect to see just by chance. Methods for calculating expect values are well known in the art, following the teaching of of Karlin S, Altschul S F, Proc Natl Acad Sci USA 1990 March, 87:2264-8 and Karlin S, Altschul S F, Proc Natl Acad Sci USA 1993 Jun. 15; 90(12):5873-7 and Altschul, S F (1993), J. Mol. Evol. 36:290-300. Users are able to control the least degree of similarity displayed in alignment reports by specifying a maximum expect value.

Methods for alignment of polypeptide sequences are well known in the art. Optimal alignment of sequences may be conducted by the local homology algorithm of Smith and Waterman, Adv. Appl. Math. 2:482 (1981); by the homology alignment algorithm of Needleman and Wunsch, J. Mol. Biol. 48:443 (1970); by the search for similarity method of Pearson and Lipman, Proc. Natl. Acad. Sci. 85:2444 (1988); by computerized implementations of these algorithms, including: CLUSTAL in the PC/Gene program by Intelligenetics, Mountain View, Calif., GAP, BESTFIT, Basic Local Alignment Search Tool (BLAST), FASTA, and TFASTA in the Wisconsin Genetics Software Package, Genetics Computer Group (GCG.RTM. programs, Accelrys, Inc., San Diego, Calif.); the CLUSTAL program is well described by Higgins and Sharp, Gene 73:237-244 (1988); Higgins and Sharp, CABIOS 5:1 51-153 (1989); Corpet et al., Nucleic Acids Research 16:10881-90 (1988); Huang et al., Computer Applications in the Biosciences 8:1 55-65 (1992), and Pearson et al., Methods in Molecular Biology 24:307-331 (1994). The BLASTP similarity search program can be used to align protein query sequences against protein database sequences. See, Current Protocols in Molecular Biology, Chapter 19, Ausubel et al., Eds., Greene Publishing and Wiley-Interscience, New York (1995).

The current methods for alignment of polypeptide sequences are all either extremely resource intensive or they sacrifice accuracy to reduce computer processing requirements. Reduced accuracy in algorithms such as BLAST is manifested by missing statistically significant alignments found by more resource intensive algorithms such as Smith-Waterman.

Local alignments, which align portions of a query polypeptide with similar segments from a database of subject polypeptides, are important because proteins that have a significant biological relationship to one another often share only isolated regions of sequence similarity. Global-local and global alignments can be beneficial when avoidance of false homology is a concern. Global-local alignments require that every amino acid of the query polypeptide be optimally aligned for similarity with a subset of the subject polypeptide. Global alignments require that every amino acid of the shorter sequence be optimally aligned for similarity with an amino acid of the longer sequence.

Currently, the BLAST or Lipman and Pearson FASTA algorithms are used to perform all three types of alignments. In addition to BLAST and FASTA, local alignments are performed using the Smith-Waterman algorithm and global alignments are performed using the Needleman-Wunsch algorithm. State-of-the-art alignment accelerators rely upon massive parallelism of these algorithms, either on Field Programmable Gate Arrays (FPGAs) or Central Processing Unit (CPU) clusters.

The Smith-Waterman local alignment algorithm and the Needleman-Wunsch global alignment algorithm from which it originated are very similar. Both construct two-dimensional arrays with the query sequence in one dimension and the subject sequence in the other. The similarity scores of all possible pairs are calculated and stored in the cells of this two-dimensional array. A running score is calculated for each cell using the maximum of:
(1) The cell to the above-left plus the cell similarity score
(2) Any cell above minus a distance-based query gap penalty plus the cell similarity score
(3) Any cell to the left minus a distance-based subject gap penalty plus the cell similarity score
   All possible comparisons are represented by pathways through this array. A trace-back from high-scoring cells defines a high-scoring alignment. The Smith-Waterman algorithm selects high-scoring endpoints anywhere within the matrix. The Needleman-Wunsch algorithm only considers high-scoring endpoints at the edge of the matrix.

The Smith-Waterman and Needleman-Wunsch algorithms share a common strength; they do an excellent job of finding all high-scoring local and global alignments respectively. The weaknesses of the both algorithms are:
(1) The number of simultaneous parallel computations is limited to the lesser of the query length and the subject length.
(2) The entire matrix must be maintained in memory throughout the alignment process. This can be very memory intensive since the size of the matrix is the product of the query length times the subject length and each cell consists of both the running similarity score and a trace-back value which indicates if the score was computed from the cell above, left, or above-left.
(3) The algorithm is very resource intensive. For example, aligning a 100 amino acid query sequence with a database of 500 million proteins requires the computation of 50 billion cells.
(4) There is no commonality between the simultaneous cell computations; each compares a different query character with a different subject character, eliminating any opportunity to exploit shared processing between cell computations.
(5) A list of pointers to high-scoring cells within the matrix must be maintained and each must be traversed backward through the trace-back pointers to find the path and origin of the alignment. Lower scoring alignments with the same origin must be discarded as duplicates.

The BLAST and FASTA algorithms operate quite differently. For each protein sequence in the subject database, the BLAST algorithm and its FASTA predecessor create indexes of very short protein sequences. Typically, these sequences are only three amino acids in length. When a search is performed, the index files are used to find the locations in the subject database that match indexed segments of the query. If the short matches occur within a promising proximity with each other, then BLAST and FASTA examine the related subject segment for a potential alignment.

This technique allows the BLAST and FASTA algorithms to quickly reduce the scope of the subject database which results in the algorithms' strength; they are much less resource intensive and thus faster than the Smith-Waterman algorithm. This speed, however, comes at the cost of a sacrifice in quality. The weaknesses of the both algorithms are:
(1) Because gaps can occur in the middle of indexed sequences, and because dissimilar amino acids can cause an index lookup miss, similar sequences can be omitted from BLAST and FASTA results. A 5% or higher error rate is not uncommon.
(2) It is not possible for BLAST and FASTA to find short sequences with any degree of reliability. Sequences containing less than 15 amino acids are particularly susceptible to being missed.
(3) It is necessary to maintain updated indexes in order for BLAST to perform properly. This requires administrative oversight.

### SUMMARY

The present invention employs a novel and efficient massively parallel processing approach to reduce the resources required for polypeptide alignments without sacrificing alignment quality. This method results in a significant reduction in the time and computer resources required to identify statistically significant alignments. To accomplish this, a filter algorithm is employed to efficiently scan a collection of polypeptides and identify segments which are similar to a polypeptide query. The filter identifies sequences of amino acids within the polypeptide database which have a high probability of producing gapped and un-gapped alignments with a statistically significant similarity to the query sequence. The filter, generally implemented in a Field Programmable Gate Array (FPGA) or Application Specific Integrated Circuit (ASIC), is designed to operate in synchronous logic and exploit the burst read feature of synchronous memories. Identified protein fragments are rigorously examined, the subjects with the greatest similarities are determined, and a sequence alignment report is produced.

The filter addresses the weaknesses of current sequence alignment algorithms by doing the following:
(1) Compare a single query polypeptide against an array of subject polypeptides in parallel. This array can be any length and can consist of multiple subjects delimited by a special null character. The last subject does not need to be entirely contained in the array. This approach eliminates the Smith-Waterman and Needleman-Wunsch query length restriction on the number of parallel processes and limits the in-memory requirement to the current amino acid comparisons rather then requiring the entire matrix in memory.
(2) Store only the alignment score associated with each element of the array, eliminating the trace-back overhead associated with the Smith-Waterman and Needleman-Wunsch approaches.
(3) Abstractly score the similarity of amino acid pairs by assigning an exact, similar and dissimilar score for comparisons to the current query amino acid and using these scores on all of the parallel amino acid comparisons, thus exploiting the common query amino acid and reducing resource requirements associated with similarity matrix lookup.
(4) Approximate the gap location by allowing gaps at sub-optimal locations to further reduce resource requirements. It is only necessary for the filter to recognize that a gap is probable and to approximate the running similarity score derived from the gapped alignment.
(5) Scan the entire subject database while performing a burst read to reduce memory access overhead and ensure 100% coverage of possible high-scoring alignments. This approach overcomes the BLAST and FASTA limitations by identifying all high-scoring alignments and doing so for a query sequence of any length.
(6) Record high-scoring alignments and send a summary of the observation to a post-filter processor for parallel examination of the prospective alignments.

For each candidate alignment identified by the filter, the post-filter processor examines the portions of the subject sequences identified by the filter. This is done by computing the optimum alignment within the subject portion using exact similarity scores and optimum gapping locations. These scores are used to identify the top-scoring subjects which are rigorously examined. All alignments within these subjects, which exceed a statistically significant score, are reported to the requestor.

### SUMMARY OF DRAWINGS

FIG. 1 is a block diagram illustrating the top-level data flow of the present invention.

FIG. 2 is a block diagram illustrating the filter logic which scans the protein database for potential statistically significant similar alignments with the query polypeptide.

FIG. 3 shows the similarity indicator matrix that is derived from the BLOSUM 62 similarity matrix.

FIG. 4 shows the structure of the query data array which contains each query character and the related abstract similarity scores for matches with subject characters.

FIG. 5 shows the structure of the match properties registers which contain values related to matches with the current filter query character.

FIG. 6 shows the structure of the alignment properties which are used by the score and threshold check processes to track each of the parallel alignments evaluated by the filter.

FIG. 7 shows the preferred parallel pipeline structure employed by the filter.

FIG. 8 shows the abstract correlation table derived from the BLOSUM 62 similarity matrix.

FIG. 9 shows the structure of the subject polypeptide database.

FIG. 10 shows the layout of the subject directory which shows the address and description of each subject polypeptide in the subject polypeptide database.

FIG. 11 shows the layout of the database of filter abstraction controls which contains similarity and abstract score data for each supported similarity matrix.

FIG. 12 shows the layout of the statistical parameters table which contains the statistical constants used by the used by the Karlin and Altschul algorithm to compute the minimum statistically significant of an alignment score.

FIG. 13 shows an example of a table of similarity factors that contains the threshold adjustment factor used for different levels of filter sensitivity.

FIG. 14 shows the layout of a hit record which records a probable high scoring alignment identified by the filter.

FIG. 15 shows the layout of the hit list packet of hit records.

FIG. 16 shows the layout of an alignment window which identifies the bounds of a probable high scoring alignment in a given subject polypeptide.

FIG. 17 shows the cell specific and global variables used by the alignment window exploration algorithm.

FIG. 18 shows an alignment window exploration algorithm example of an alignment of a 19 character query in a window with a six character alignment width.

FIG. 19 shows a traditional alignment representation of the FIG. 18 alignment example.

FIG. 20 shows an example of the parallel shared maximum comparisons in an array of eight running alignment scores.

FIG. 21 shows an example of the computation of the alternate query gap alignment score.

FIG. 22 shows an example of three polypeptides in the industry standard FASTA format.

FIG. 23 shows an example of an alignment used by the National Center for Biotechnology Information (NCBI).

FIG. 24 shows the codes used for the 20 genetically coded amino acids and three special cases.

FIG. 25 shows the BLOSUM 62 matrix, one of many industry standard similarity matrices.

### DETAILED DESCRIPTION

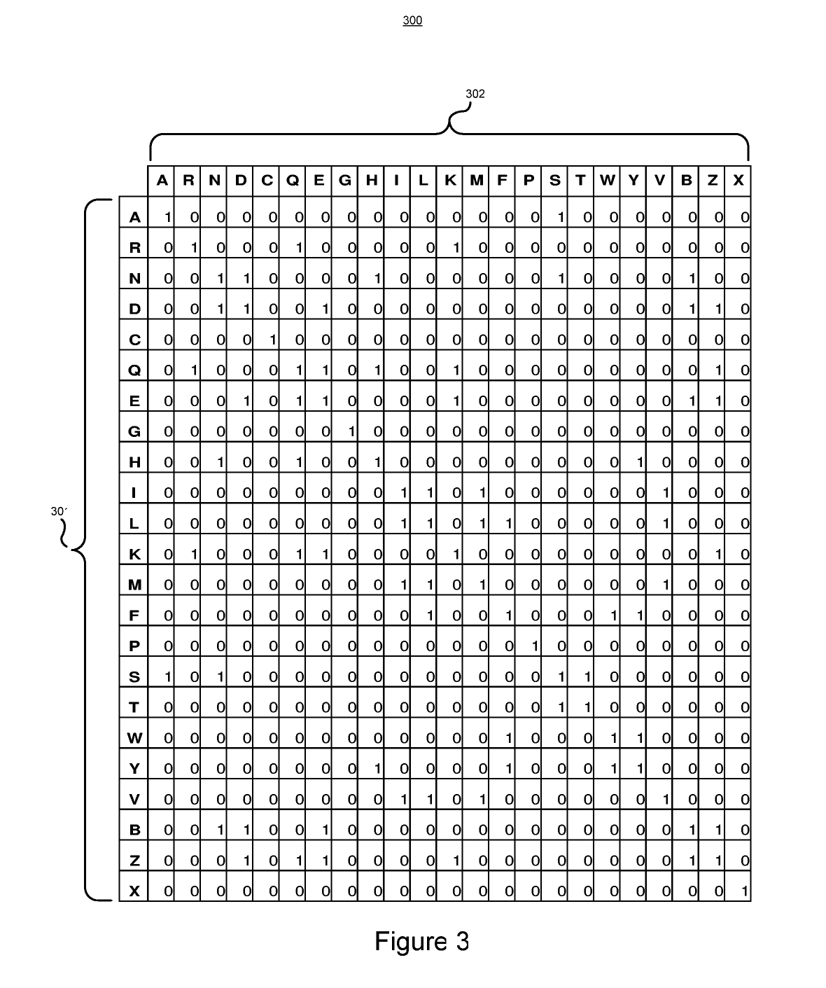

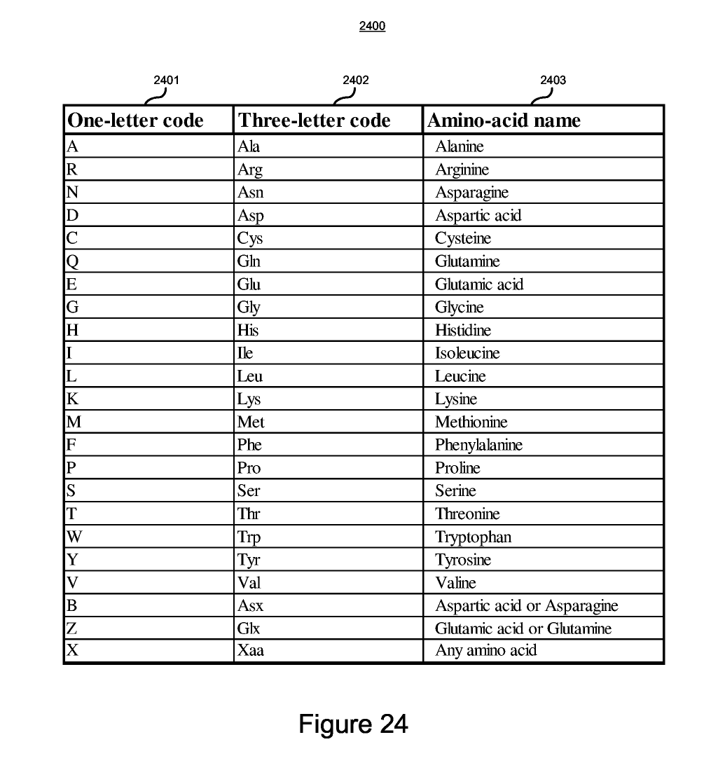

FIG. 24 shows the 23 commonly used amino acid codes 2401 with their corresponding three character codes 2402 and the scientific names 2403. The letters, referred to herein as query characters and subject characters, are also used in FIGS. 3, 8, 18, 19, 22, 23, and 25.

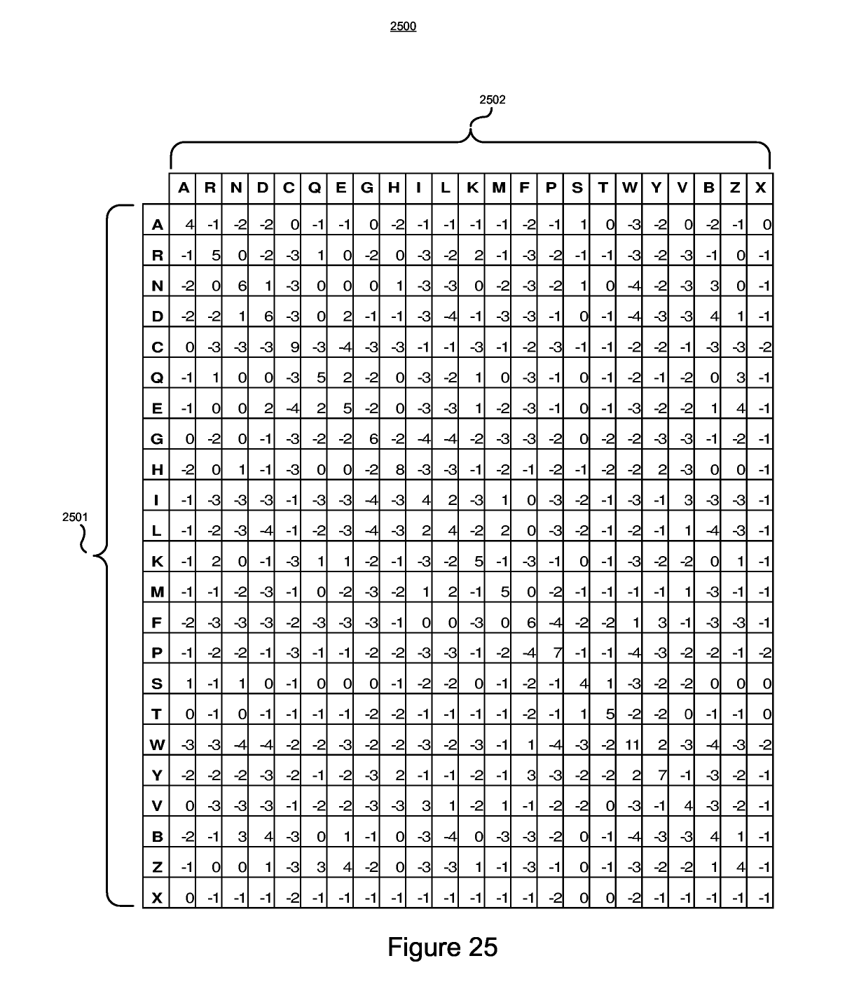

The degree of similarity or dissimilarity between any two amino acids has been defined and encoded in a number of industry standard similarity matrices. An example of the BLOSUM 62 similarity matrix is shown in FIG. 25.

A similarity indicator is a measure of similarity abstracted from a similarity score contained within a similarity matrix. In the preferred embodiment, the similarity indicator is a Boolean indicating if the amino acid pair is relatively similar of relatively dissimilar. In other embodiments, a lesser degree of abstraction can be used. For example, the similarity indicator might be ternary with measures of similar, neither similar nor dissimilar, and dissimilar.

FIG. 3 shows the similarity indicator matrix 300 that is derived from the BLOSUM 62 similarity matrix 2500. The conversion from the similarity matrix 2500 to the similarity indicator matrix 300 is performed by a simple translation of each cell of the similarity matrix 2500. If the cell of the similarity matrix found at the intersection of a query amino acid column 2502 and subject amino acid row 2501 has a score greater than zero, then the indicator in the corresponding cell of the similarity indicator matrix at the intersection of the query amino acid column 302 and the subject amino acid row 301 is set to one. Otherwise it is set to zero.

In the preferred embodiment, the conversion of each industry standard similarity matrices into a similarity indicator matrix is performed once and stored in a database of filter abstraction controls 121 for subsequent usage by the invention.

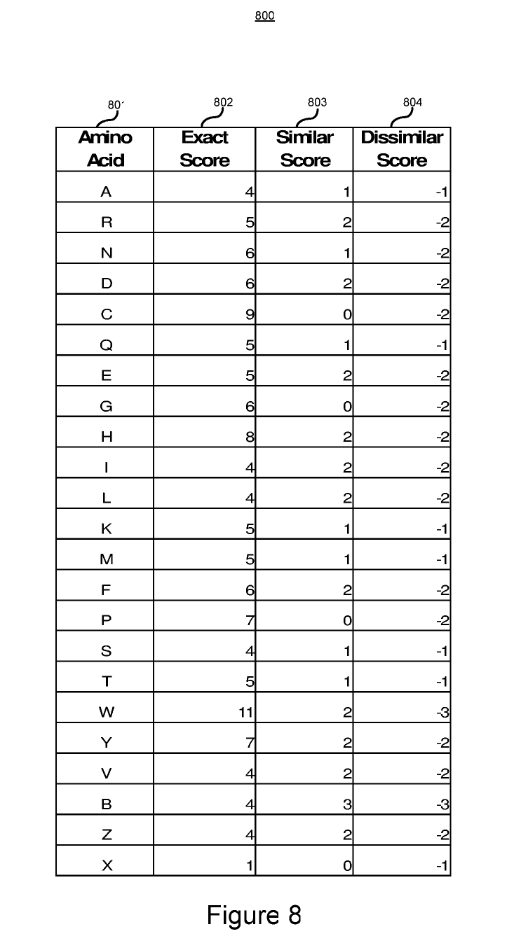

Another table derived from a similarity matrix is the abstract correlation table 800. FIG. 8 was derived from the BLOSUM 62 similarity matrix. It is populated with each amino acid 801, its exact score 802, an abstracted similarity score 803 and an abstracted dissimilarity score 804.

The exact score 802 is the score from the intersection of each amino acid with itself. In the preferred embodiment, the abstracted similarity score 803 is the average score for all similar amino acids weighted by the frequency of their occurrence within living organisms. The abstracted dissimilarity score 804 is computed in the same manner but as a weighted average of the dissimilar amino acids.

In other embodiments, there may be additional abstract scores such as a neither similar nor dissimilar score in a ternary similarity indicator implementation. Additionally, in other embodiments, the scores within the abstract correlation table 800 may be derived by methods other then the described weighted average method.

In the preferred embodiment, the 20 genetically coded amino acids and three special cases are encoded into a five-bit character code. In other embodiments, the number of supported amino acids and the character encoding scheme may vary.

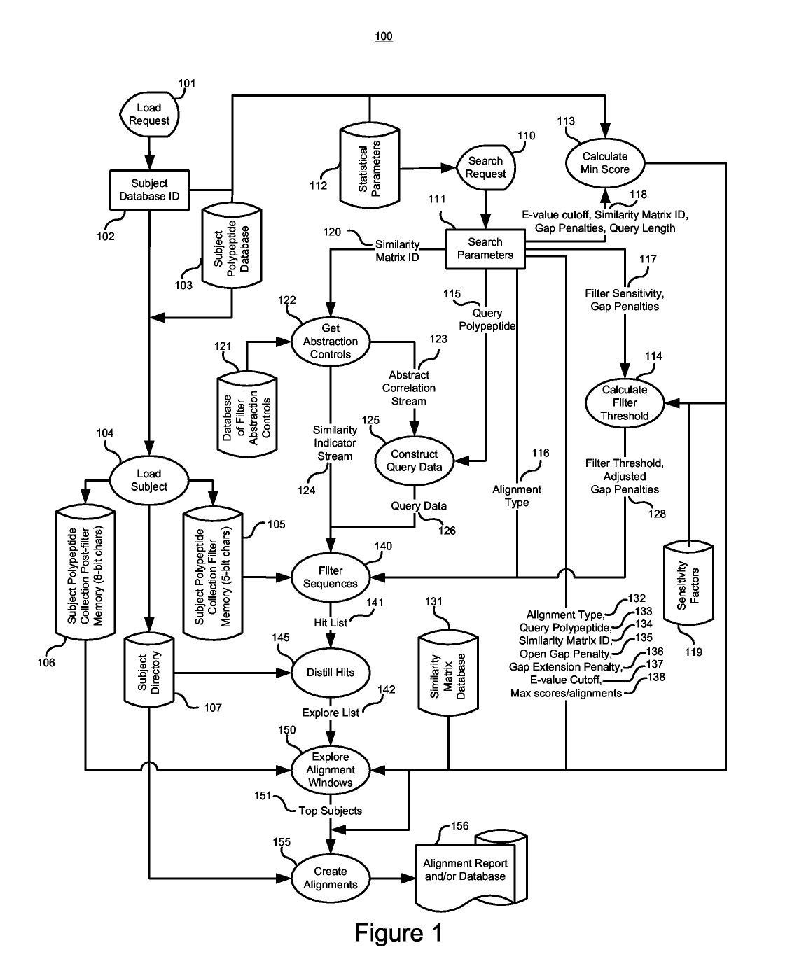

FIG. 1 illustrates the top-level flow of data 100 within the present invention. In the preferred embodiment, the user of this invention selects a previously established subject polypeptide database 103 and then searches for alignments of query polypeptide 115 within the database.

These two primary functions are represented by the two primary user initiated paths through the data flow 100; the request to load 101 a subject database and the request to search 110 for alignments of a query sequence within the loaded database.

When a load request is made, the user supplies a subject database ID 102 which identifies the subject amino acid sequence from a database 103 of subject polypeptides. In the preferred embodiment of the invention, the subject sequences consist of one or more proteins or fragments of proteins, but in other embodiments, the sequences may consist of any amino acid sequences.

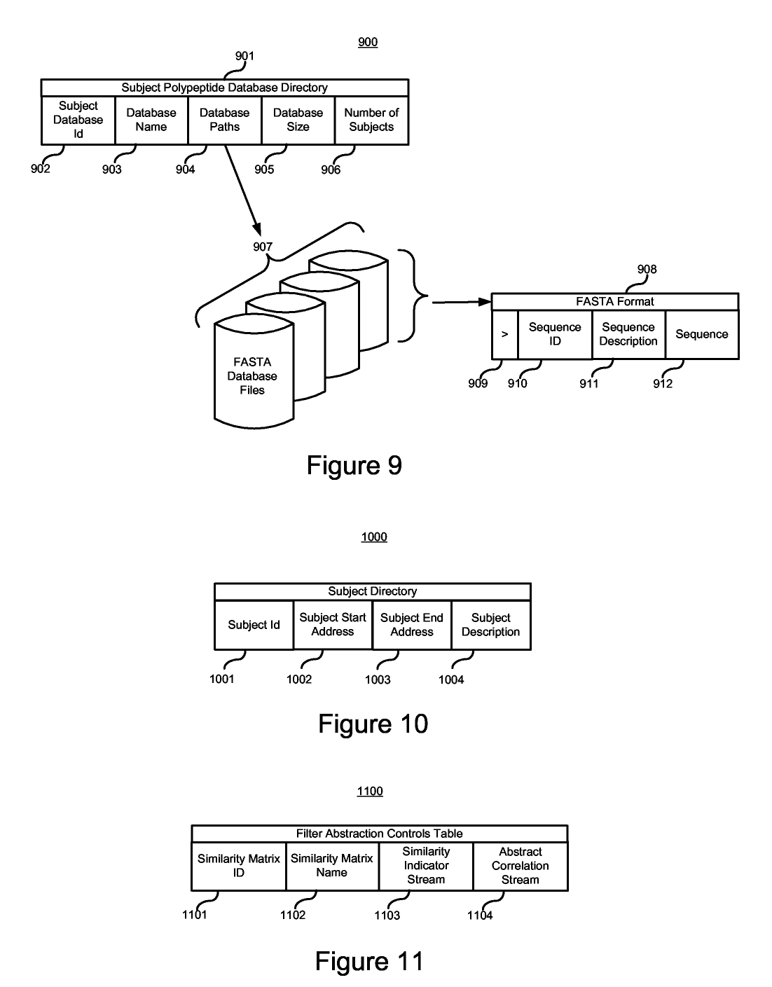

FIG. 9 shows the structure of the subject polypeptide database 900 which consists of a subject polypeptide database directory 901 and one or more files 907 containing polypeptide subjects. In the preferred embodiment, the polypeptide subjects are stored in the industry standard FASTA format 908, but in other embodiments, a variety of formats may be used.

The subject polypeptide database directory 901 consists of one or more records. Each record corresponds to a subject polypeptide collection uniquely identified by the subject database ID 902. The database name 903, database size 905, and the number of subjects 906 in the polypeptide collection are stored in each record along with one or more paths 904 to the subject data.

In the preferred environment, the polypeptide collection is stored in one or more files 907 encoded in the industry standard FASTA format. In other embodiments, any format or storage means may be employed.

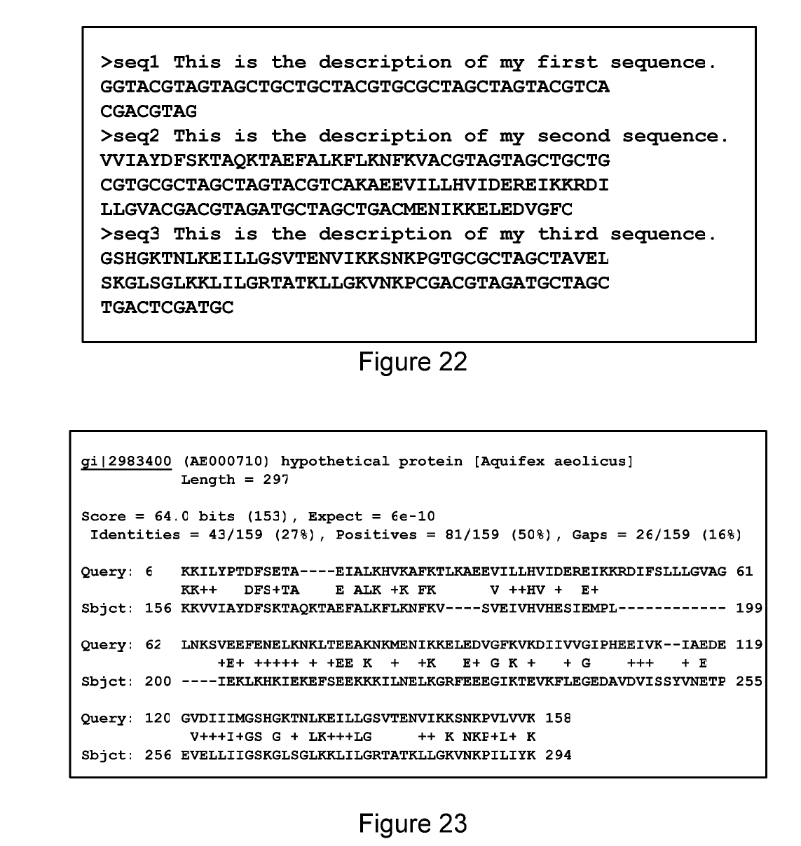

The FASTA format 908 consists of one record per subject polypeptide. Each record starts with the special character “>” 909 followed by a sequence ID 910, a sequence description 911 and the amino acid sequence 912 making up the polypeptide. The sequence 912 is stored in variable length segments separated by carriage returns. In a given FASTA file, the segments are typically formatted to the same length. FIG. 22 shows an example of three polypeptides stored in FASTA format.

The load subject process 104 loads two copies of the selected subject polypeptides from the subject polypeptide database 103, into two memories.

The first copy is loaded into the subject amino acid sequence collection filter memory 105 for subsequent access by the filter sequences process 140. The reading of this memory is dedicated to the filter process which eliminates access contention from other processes. In the preferred embodiment, this memory consists of synchronous dynamic random access memory (SDRAM), but any storage means which can be rapidly accessed by the filter process 140 may be employed.

In the preferred embodiment, the subject amino acid sequence collection filter memory 105 is converted by the load subject 104 process from the standard ASCII encoding of amino acid characters to a packed 5-bit character code used by the filter sequences process 140. The special null subject character is assigned the value of zero and the 23 amino acids are assigned the consecutive values from 1 to 23.

This method reduces memory requirements and speeds memory access by the filter process 140. In other embodiments, various character encoding schemes may be employed.

The second copy of the selected subject polypeptides from the subject polypeptide database 103 is loaded into the subject amino acid sequence collection post-filter memory 106 for subsequent access by the explore alignment windows process 150. This memory is accessed to score potential alignments identified by the filter 140 while the filter 140 continues to scan the subject collection for additional potential alignments. In the preferred embodiment, ASCII encoded amino acids are stored in synchronous dynamic random access memory (SDRAM), but any storage means which can be rapidly accessed by the explore alignment windows process 150 may be employed.

The load subject process 104 further creates a subject directory 107 of the sequences within the subject sequence collection 105. FIG. 10 shows a detailed view of the subject directory 107 which is preserved for later use by the explore alignment windows process 150. The directory 1000 consists of the subject database ID 1001 and the storage start address 1002, end address 1003, and the sequence description 1004 of each subject sequence within the subject amino acid sequence collection 105.

When a search request 110 is made, the user selects search parameters 111 comprising; similarity matrix ID, query polypeptide, expect value cutoff, maximum reported scores, maximum reported alignments, alignment type, open gap penalty, and gap extension penalty. These parameters are used to generate inputs for both the filter process 140 and the explore alignment windows process 150.

The search request 110 process collects user inputs from an input means. In the preferred embodiment, this input means is a request screen, but in other embodiments, the input means can consist of requests from another application.

The search inputs 111 comprise:
(1) The alignment type of local, global or global-local
(2) The query polypeptide which will be aligned against the subject amino acid sequence collection
(3) The ID of the similarity matrix to use for alignment scoring
(4) The open gap and extend gap penalties with their default values looked up from the statistical parameters 112 depending upon the selected similarity matrix
(5) The desired filter sensitivity
(6) The expect value cutoff which specifies the maximum acceptable expect value and consequently the least statistically significant alignment of interest
(7) The maximum number of reported scores and alignments.

The calculate min score 113 process calculates the lowest acceptable statistically significant score. In the preferred embodiment, the user specifies a maximum expect value which is used by the present invention to compute the minimum alignment score acceptable to the user. The minimum alignment score is calculated using the algorithm of Karlin and Altschul (1990) Proc. Natl. Acad. Sci. USA 87:2264-2268 as known by those skilled in the art.

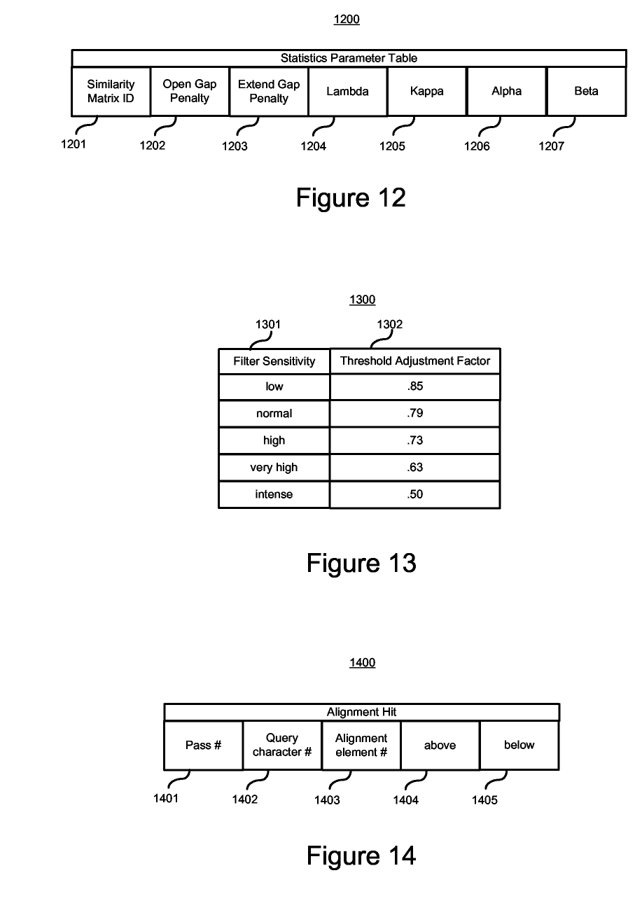

The statistical parameters 112 used by the calculate min score 113 process are shown in FIG. 12. The statistical parameters table 1200 contains the lambda 1204, kappa 1205, alpha 1206 and beta 1207 constants used by the Karlin and Altschul algorithm for each valid combination of similarity matrix ID 1201, open gap penalty 1202, and gap extension penalty 1203.

The number of reported alignments are additionally constrained in the preferred embodiment by a user specified maximum number of displayed scores and alignments 138 which restrict the results to the most statistically significant scores within the maximum number of reported alignments.

In other embodiments, other methods to rank and constrain the reported alignments may be employed.

The Karlin and Altschul method uses the expect-value cutoff, similarity matrix, gap penalties, and the length of the query amino acid sequence inputs 118 to the calculate minimum score process 113. The minimum score is calculated using the statistical parameters 112 for the selected similarity matrix and gap penalties as well as the length of the selected subject amino acid sequence collection and the number of subject sequences, looked up from the subject polypeptide database 103 by the selected subject database ID 102. The minimum statistically significant score is passed to the explore alignment windows 150 process and to the calculate filter threshold 114 process.

The filter sensitivity and open and extend gap penalties 117 are passed from the request search 110 process to the filter threshold 114 process. FIG. 13 shows an example 1300 of a table of similarity factors 119 which is indexed into by the filter sensitivity 1301 to determine the threshold adjustment factor 1302. The calculate filter threshold 114 process calculates a filter threshold by multiplying the minimum score passed from the calculate min score 113 process by the threshold adjustment factor and rounding it to the nearest integer. Similarly, the open and extend gap penalties are multiplied by the threshold adjustment factor 1302 and rounding it to the greater of the nearest integer or one.

The similarity factors example 1300 is employed in the preferred embodiment but the number of filter sensitivity 1301 categories and their threshold adjustment factors 1302 may be modified to suit a particular embodiment, subject database or similarity matrix.

The filter threshold and adjusted gap penalties 128 are passed to the filter sequences 140 process. These vales determine the filter's level of sensitivity and will result in varying numbers of probable alignments. Greater sensitivity results in a greater number of probable alignments, a greater amount of post-filter effort, and potentially a higher quality alignment report.

FIG. 11 shows the layout of the database of filter abstraction controls 121. The similarity matrix ID 1101 is the index to the database of filter abstraction controls 1100. For each similarity matrix, the database contains the corresponding similarity matrix name 1102, similarity indicator stream 1103, and abstract correlation stream 1104.

An example of a similarity matrix name 1102 is BLOSUM 62.

FIG. 3 shows an example of the similarity indicator table for the BLOSUM 62 similarity matrix. Each cell of the similarity indicator table 300 represents the value of a similarity indicator at the intersection of a subject amino acid 301 with a query amino acid 302.

The similarity indicator stream 1103 is a stream of the similarity indicator values contained in the similarity indicator table 300.

The abstract correlation stream 1104 is a stream of the scores contained in the abstract correlation table 800.

The similarity matrix ID 120 from the input search parameters 111 is passed to the get abstraction controls 122 process which uses the similarity matrix as an index into the database of filter abstraction controls 121 to retrieve the corresponding similarity indicator stream 1103, and abstract correlation stream 1104.

The get abstraction controls 122 process passes the similarity indicator stream 124 to the filter sequences 140 process where it will be used to determine which abstract correlation score to use when comparing a pair of amino acids.

The get abstraction controls 122 process passes the abstract correlation stream 123 to the construct query data 125 process which combines the abstract scores with the query polypeptide 115 and creates the query data 126 which is passed to the filter sequences 140 process where it will be used to drive the iterations of the filter array calculations.

The search request 110 process passes the alignment type 116 input parameter to the filter sequences 140 process where it is used to control the filter behavior so that probable high-scoring alignments reported by the filter sequences 140 process are restricted to those that will be possible with the given alignment type.

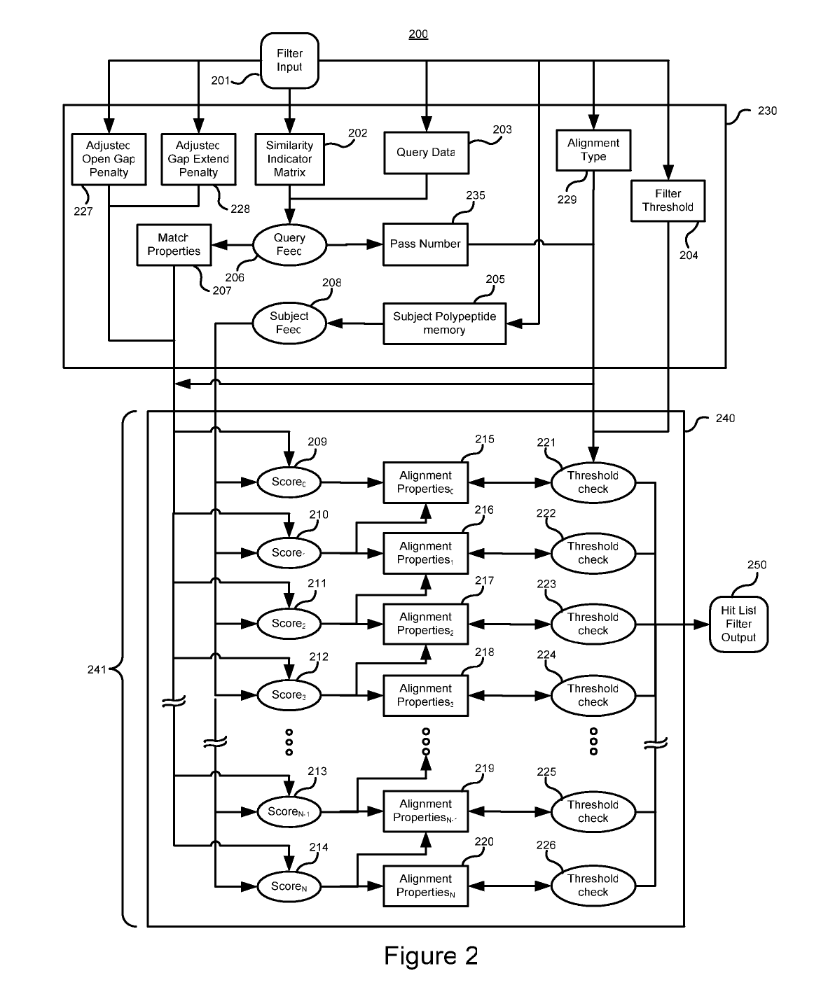

FIG. 2 shows the data flow 200 within the filter sequences 140 process. The filter identifies alignments of a query polypeptide with amino acid sequences from a collection of subject polypeptides which have a high probability of having a statistically significant similarity.

There are two major sections to the filter sequences 140 process. The filter control 230 section receives the filter inputs and controls the iterative flow of sequence data to the filter fabric 240 section. The filter fabric 240 calculates running sums, checks them against the filter threshold 204, and outputs 250 the alignment bounds of subject sequences which exceed the filter threshold 204.

In the preferred embodiment, the filter sequences 140 process is implemented in synchronous logic in an FPGA or ASIC. With successive clock cycles, the filter 140 processes successive query characters. In a given clock cycle, the current query character is related, in parallel, to each element of an array containing a sequence of subject characters.

The filter inputs 201 consist of a similarity indicator matrix 202, a set of query data 203, a filter threshold 204, a subject polypeptide collection 205, the adjusted gap penalties 227 and 228, and the alignment type 229.

The input similarity indicator matrix 202 and the query data 203 are passed to the query-feed 206 process which, in successive clock cycles, walks through the query polypeptide from the first to the last character. The pass number 235 is initialized to zero.

For each query character, the query-feed 206 process sets a group of registers collectively referred to as the match properties 207. FIG. 5 shows the structure of the match properties 500 which consist of the current query character 501, the score if the subject character matches the query character 502, the score if the subject character is similar to the query character 503, and the score if the subject character is dissimilar from the query character 504.

Additionally, the query-feed 206 process selects the column of the similarity indicator matrix 202 which corresponds to the current query character 502, and loads it into a bitmap register 505 in the match properties 207.

In the preferred embodiment, the bitmap register 505 consists of 23 bits, one for each of the commonly recognized DNA related amino acids, as shown in the FIG. 3 example. In other embodiments, a different number of amino acids may be encoded into the similarity indicator matrix 202 and the subset bitmap register 505.

In the preferred embodiment, the similarity indicators are binary, indicating similar or dissimilar. Hence, the bitmap register 505 contains only one bit for each amino acid. In other embodiments, the bitmap register 505 may contain more than one bit per amino acid, depending upon the number of degrees of similarity supported by the embodiment.

Sharing the match properties 207 with all parallel elements of the filter fabric 240 greatly reduces the logic compared with a Smith-Waterman approach in which the parallel processes are all operating from different query characters.

In parallel with the query-feed 206 process load of the first query character, the subject-feed 208 process loads an array of subject character registers from the subject polypeptide memory 205. The subject polypeptide memory 205 is the same memory as the subject polypeptide collection filter memory 105 in FIG. 1.

As each successive query amino acid character is processed, the subject-feed 208 process shifts the array of subject amino acid characters up by one character, discarding the top character and appending the next character from the subject polypeptide memory 205 to the end of the array.

The filter fabric 240 consists of an arbitrary number of parallel processing elements 241 represented by the subscript “N” in the score_{N} 214, and threshold check_{N} 226 processes and the alignment properties_{N} 220 data store. The number of elements can be expanded to fully utilize the hardware available. In the preferred embodiment, a few hundred to a few thousand parallel filter elements 241 are employed.

The parallel score processes 209 through 214 computes a running alignment score corresponding to each element of the subject array and records the number of array elements above and below which contributed to the running alignment score. This data is maintained in a group of registers collectively referred to as the alignment properties 215 through 220.

The alignment properties 600 shown in detail in FIG. 6 consists of six fields; a subject character 601, a running alignment score 602, the number 603 of array elements above the current element which contributed to the alignment score, the number 604 of array elements below the current element which contributed to the alignment score, an alternative subject gap alignment score 605, and hit Boolean 606 indicating if the alignment has exceeded the filter threshold 204.

The open 227 and extend 228 gap penalties are fanned out to each element of the filter fabric 240 from the filter's adjusted gap penalties 227 and 228 input.

The running alignment score 602 is computed by each of the score processes 209 through 214 by adding to the current running alignment score the maximum of:
(1) The similarity score derived by comparing the subject character 601 to the current query character.
(2) The alternative subject gap alignment score 605.
(3) The alternate query gap alignment score.

FIG. 21 shows an example of the computation of the alternate query gap alignment score 2106. The example 2100 shows an array 2101 of alignment scores 602, one for each element of the filter fabric 240. For each, an alternate query gap alignment score is computed as shown in the example 2100 for one element 2103, referred to as the gap-to element.

An embodiment specific maximum query gap reach 2102 defines the number of filter fabric 240 elements that are examined to locate the maximum above alignment score 2105. The distance above in elements, from the gap-to element to the element where the maximum alignment score 2105 is found, is the query gap length 2104.

The alternate query gap score is computed from the maximum above alignment score 2105 minus the query gap length 2104 times the adjusted gap extension penalty 228 minus the adjusted open gap penalty 227 as shown in the example calculation 2106.

The value of the max query gap reach 2102 is limited to the number of elements above a given element of the filter fabric 240. In the preferred embodiment, the max query gap reach 2102 is further limited to 8 elements, however, in other embodiments; different values for the max query gap reach 2102 can be employed. This value indicates the maximum query gap length that the filter will allow without charging another open gap penalty. Because the filter is approximating alignment scores, selecting the optimal gap position or penalty isn't required.

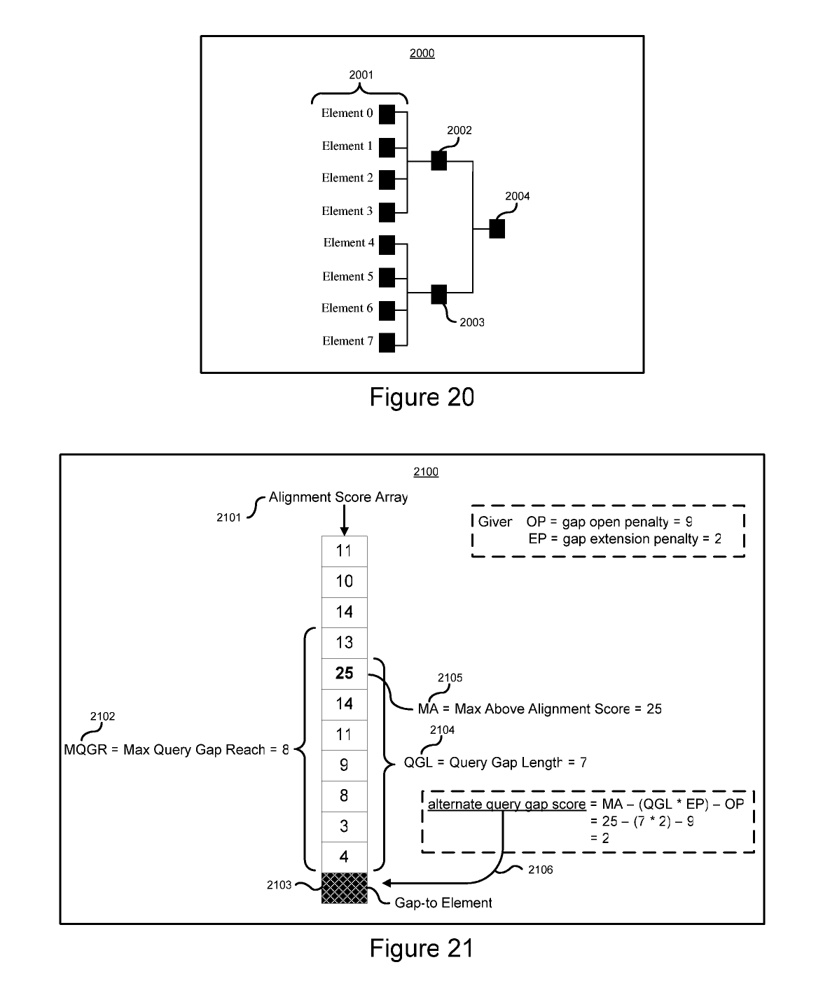

In the preferred embodiment, in parallel combinatorial logic, the maximum alignment score 602 of even numbered elements of the alignment properties array 215 through 220 are compared against the odd numbered element alignment score 602 below them. FIG. 20 shows a small example of an array 2001 of eight of the alignment properties 215 through 220. For each element pair, a bit is set to indicate which is greater and the maximum value is stored in a register. If they are equal, the bit is set to indicate that the lower element is greater.

Similarly, pairs of the new maximums are compared resulting in the maximum of four elements 2002 and 2003. Pairs of the maximum of the four elements 2002 and 2003 are compared in the same manner producing octet maximums 2004.

The registers produced by these comparisons are shared between elements of the score processes 209 through 214 to reduce the logic required to identify the maximum alignment score 602 above. If a null subject character 601 occurs within the range of a pair, quad, or octet comparison, then the maximum is limited to those alignment scores 602 below the element where the null occurred. This prevents illegal query gaps from one subject to another.

Score processes 209 through 214 also each calculate an alternative subject gap alignment score 605 to be used in the next cycle. The new subject gap alignment score 605 is stored with the alignment properties associated with the element above them in the fabric 240. The alternative subject gap alignment score 605 is set to the maximum of the current subject gap alignment score 605 minus the adjusted gap extension penalty or the newly computed running alignment score minus the adjusted open gap penalty.

If the newly computed alignment score 602 is negative and the alignment type 229 is local or local-global, then the alignment score 602 is set to zero. Otherwise, if the score was changed because of a subject gap then the gap size, which was initialized to the query gap length 2104, is set to a negative one.

If the score was changed due to a gap, then the gap size is subtracted from the below gap 604 and the gap size is added to the above gap 603. If, after the adjustment, the below gap 604 is less than zero, then it is set to zero and if the above gap 603 is less than zero, then it is set to zero.

If the alignment type 229 is local or if the query-feed 206 process has reached the last query character, then the threshold check processes 221 through 226 compare the alignment score 602 for each element of the filter fabric 240 against the filter threshold 204 and sets the Boolean hit bit 606 indicator if the alignment score 602 exceeds the filter threshold 204.

While the preferred embodiment supports all alignment types, it is possible to streamline an embodiment by supporting limited alignment types.

If the subject character 601 in an array element is the special subject-delimiting null character and the element's hit bit 606 has been set, then a hit is recorded.

FIG. 14 shows a hit record 1400. To record a hit, the pass number 1401 is set to the current pass number 235, the query character number 1402 is set to the offset of the current element of the query data array 203, the alignment element number 1403 is set to the respective element of the filter fabric 240, the above value 1404 is set to the alignment properties'above gap 603 value and the below value 1405 is set to the alignment properties'below gap 604 value.

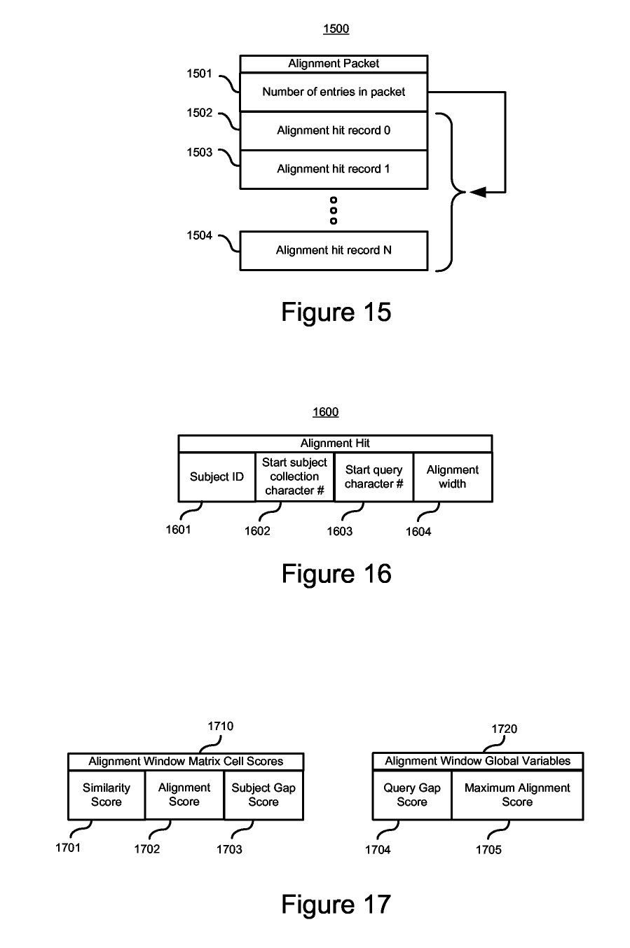

Hit records 1400 are collected into hit list packets 1500 by the filter process 140. The hit list packet 1500, shown in FIG. 15, comprises a record count 1501 followed by a list of hit records 1502 though 1504.

Hit list packets 1500 are passed from the filter output 250 to the distill hits 145 process which, in the preferred embodiment, begins a parallel examination of the prospective alignments. The array element's hit bit 606, alignment score 602, and the contributing elements above 603 and below 604 and the subject gap alternative 605 are reset to zero.

After the query-feed 206 process reaches the last query character 403, the filter 200 does the following:
(1) For each array element which has a set hit bit 606, the filter passes the array element number, the pass number 235 and the number of contributing elements above 603 and below 604 are passed in the form of hit list packets 141 from the filter output 250 to the distill hits 145 process for parallel examination of the prospective alignment.
(2) The array element's hit bit 606, alignment score 602, and the contributing elements above 603 and below 604 and the subject gap alternative 605 are reset to zero, just as they had been when a null subject character was encountered.
(3) The current query character is reset back to the first query amino acid for a new pass by the query-feed 206 process.
(4) The pass number 235 is incremented.
(5) An array adjustment factor is calculated from the number of elements in the subject array 241 minus the number of amino acids in the query sequence, minus an array overlap factor. If the array adjustment factor is positive, the subject array contained in the subject character 601 elements of the alignment properties 215 through 220 is shifted up by the adjustment factor, discarding the top elements and adding the next subject amino acid characters from the subject polypeptide memory 205 to the bottom of the array. If the array adjustment factor is negative, the subject 601 elements of the alignment properties 215 through 220 are shifted down by the adjustment factor, discarding the bottom elements and adding the proceeding amino acid characters from the subject polypeptide memory 205 to the top of the array.

In the preferred embodiment, the overlap factor of ten is used, but other values can be used. The overlap factor allows gapped alignments to be recognized across the boundary formed by filter fabric 240 overlays of the subject amino acid sequence.

In the preferred embodiment, the subject-feed 208 process loads an array of the next subject character registers in parallel with the iteration through the query characters by the query-feed 206 process and the shifting of subject characters by the subject-feed 208 process. This prevents delay which would be caused by reading the subject character polypeptide memory at the end of each cycle through the query.

In the preferred embodiment, the subject polypeptide memory 205 is read using a synchronous memory burst read which allows the subject-feed 208 process to keep up with cycles through the query. In the event that a very short query makes this impossible, the query-feed 206 process will be delayed until the subject array is updated.

The process is repeated until the entire subject database has been filtered.

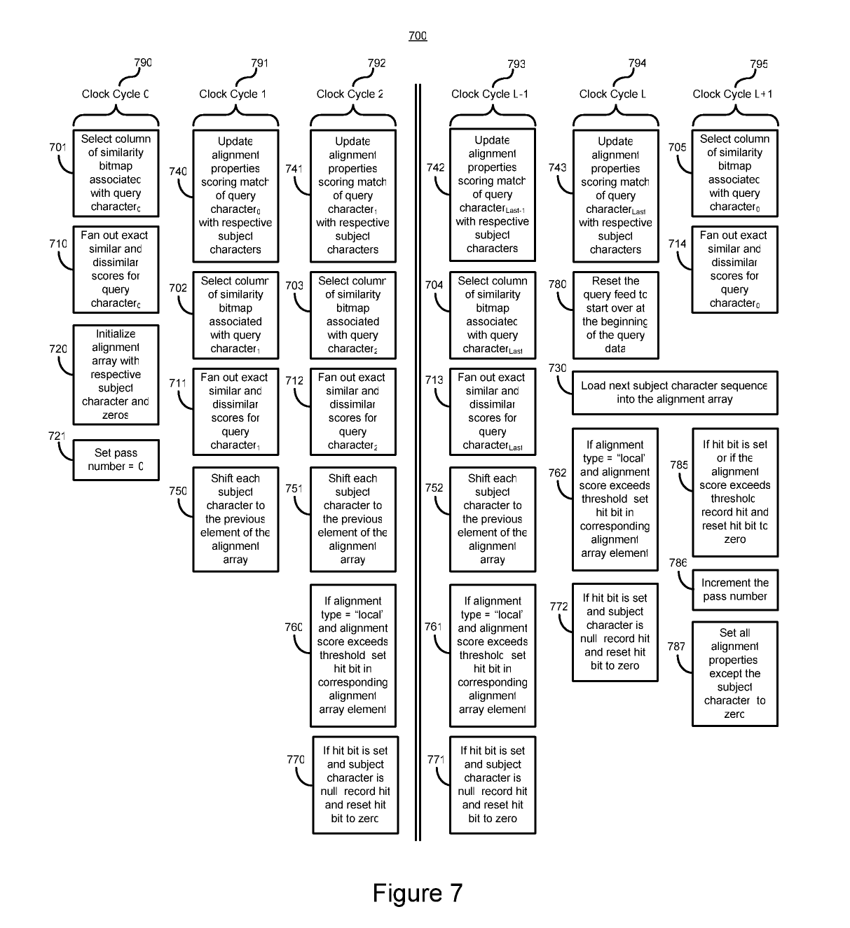

FIG. 7 shows the synchronous parallel processing architecture timing relationship 700 in the preferred embodiment between the filter 200 processes. Many other timing relationships are possible in other embodiments. The intent of FIG. 7 is to show an efficient parallel processing embodiment.

In clock cycle zero 790 four groups of parallel processes are performed.

The first process 701 selects a column of the similarity indicator matrix associated with the first query character and fans out this indicator to each of the score processes 209 through 214. This is repeated 702 through 704 with each successive clock cycle 790 through 795 until all query characters have been processed.

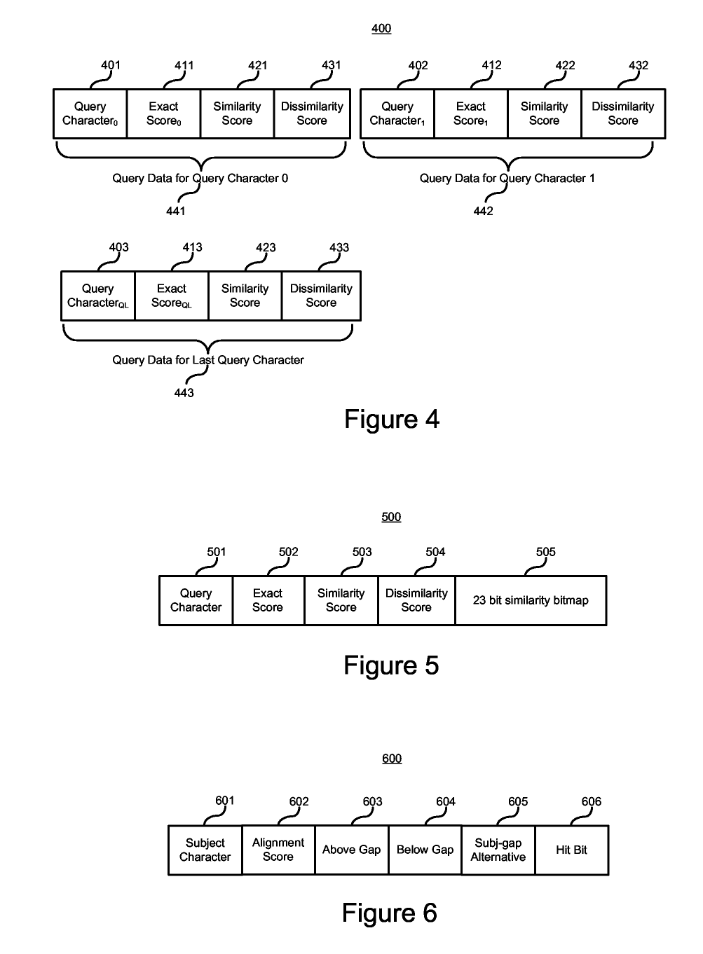

The second process 710 fans out the query data, shown in detail in FIG. 4, to each of the score processes. The query data for the first query character 441 consists of the query character 401, the exact score 411 associated with an exact match between the query amino acid and the subject amino acid, the similar match score 421 associated with a similar match between the query amino acid and the subject amino acid, and the dissimilar match score 431 associated with a dissimilar match between the query amino acid and the subject amino acid.

The query data for successive query characters are contained in subsequent segments 442 and 443 of the query data 400 array with each segment containing the same elements; query characters 402 and 403, exact match score 412 and 413, similar match score 422 and 423, and dissimilar match score 432 and 433.

The third group of process 720 initializes the array of alignment properties 215 through 220. In parallel, for each element of the array, the appropriate subject character 601 is loaded and the remaining fields 602 through 606 are set to zero.

The fourth process 721 initializes the pass number to zero.

In clock cycle one 791 four groups of parallel processes are performed.

In parallel, the first group of cycle one processes 740 updates the alignment score 602, above gap 603 and below gap 604 values for each element of the array of alignment properties 215 through 220. Additionally, for all elements of the array except the first, the subject gap alternative 605 value for the array element above is set to the maximum of the current subject gap alternative 605 minus the adjusted gap extension penalty 228 or the newly computed alignment score 602 minus the adjusted open gap penalty 227.

The second and third processes 702 and 711 are repeats of the corresponding clock cycle zero processes 701 and 710 except that the second query character is used.

The fourth group of processes 750, in parallel for all elements of the alignment properties array except the first 216 through 220, moves the current subject character 601 to the subject character 601 of the previous element of the alignment properties array 215 through 220. This effectively shifts the entire subject array up one element in the alignment properties array 215 through 220. In the preferred embodiment, this process occurs by simply wiring the output of the subject character flip-flops to the input of the flip-flops storing the subject character above causing the subject characters 601 to shift up with each clock cycle using minimal logic.

A special last instantiation of the fourth group of processes 750 stores the next subject character provided by the subject feed process 208 into the subject character field 601 of the last element 220 of the alignment properties array 215 through 220

From clock cycle two 792 through the clock cycle “L−1” 793 where “L” denotes the length of the query sequence of amino acids, the same six groups of parallel processes are performed.

The first group of parallel processes 741 and 742 are repeats of the corresponding clock cycle one process group 740 using the current subject character 601 from the respective elements of the alignment properties array 215 through 220.

The second processes 703 and 704 are repeats of the corresponding clock cycle one processes 702 except that with each clock cycle the next query character is used.

The third processes 712 and 713 are repeats of the corresponding clock cycle one processes 711 except that with each clock cycle the next query character is used.

The fourth processes groups 751 and 752 are repeats of the corresponding clock cycle one processes group 750 with the subject characters being shuffled up the lower elements of the alignment properties array 216 through 220 with each clock cycle and with the introduction of the next subject character in the special last element 220 of the alignment properties array 215 through 220.

The fifth processes groups 760 and 761 are enabled if the alignment type 229 is set to “local”. These parallel processes correspond to the check threshold processes 221 through 226. For each element of the alignment properties array 215 through 220 the alignment score 602 is compared with the filter threshold 204 and if the score 602 exceeds the threshold 204, then the hit bit 606 in the corresponding alignment properties array 215 through 220 element is set to one.

The sixth process groups 770 and 771 also correspond to the check threshold processes 221 through 226. For each of these parallel processes, if the hit bit 606 of the corresponding element of the alignment properties array 215 through 220 is set and the subject character 601 is null, then the hit is recorded and the hit bit 606 is reset to zero. A hit is recorded by creating a hit record 1400 and moving the pass number 235 to the pass number field 1401 in the hit record, setting the current query character number 1402 in the hit record, setting the alignment array element number 1403, moving the above gap 603 value to the above 1404 hit field, and moving the below gap 604 value to the below 1405 field is set to the filter output 250.

In the preferred embodiment, the recorded hits are bundled into a packet 141 of up to 4096 bytes in length. In other embodiments, any number of hits, including one or all, can be collected in a packet.

In the preferred embodiment, when the hit packet 1500 is filled, the packet is sent to the distill hits process 145 which eliminates duplication and creates an explore list 142 which is passed to the explore alignment windows 150 process where subject regions are explored for high scoring alignments. All of this is done while the filter continues, in parallel, to scan subject sequences for other high probability alignments. When the filter 140 process completes, any partial packet is sent for distillation and exploration. In other embodiments, this post-filter processing might be performed after the filter 140 process.

When clock cycle “L” 794 has been reached, the fanning out of the similarity indicators 202 and query data 203 is complete. In this clock cycle, five process groups are performed.

In the first process group 743, the alignment properties 215 through 220 are updated for the last query character just as they had been updated 740 though 742 in previous clock cycles 791 through 793.

The second process 780 resets the query index used by the query feed 206 to start over at the beginning of the query data 203.

The third process 730 loads the next subject character sequence into the alignment array 215 through 220. This process is allowed to span into the next clock cycle. In the preferred embodiment, the subject feed 208 process prepares for this process during the previous clock cycles by loading the next subject segment into a buffer of flip-flops and thus eliminating the impact of latency associated with reading from the subject polypeptide memory 205.

The fourth process 762 performs the parallel alignment threshold and hit bit check just as was done by the logic 760 and 761 in the previous clock cycles 792 and 793.

The fifth process 772 performs the parallel recording of hits at the end of subject polypeptide sequences just as was done by the logic 770 and 771 in the previous clock cycles 792 and 793.

Clock cycle “L+1” 795 represents a wrap back to the processing performed in clock cycle zero 790. The column of the similarity bitmap corresponding to the first query character is again selected 705 and the query data for the first query character is again fanned out 714.

The parallel recording of any alignments with their hit bit set 785 in clock cycle “L+1” 795 is performed for all alignment array 215 through 220 elements with a hit bit 606 set or an alignment score 602 that exceeds the filter threshold 204. The recording is done just as in the end of subject sequence check are record processes 770 through 772 in previous clock cycles 792 through 794.

The next to the last process 786 of clock cycle “L+1” 795 increments the pass number 235 in preparation for another pass through the query data 203.

The last parallel process group 787 of clock cycle “L+1” 795 initializes the alignment properties 600, except the subject character 601, in each element of the alignment array 215 through 220 to zero.

For each packet passed to it, the distill hits 145 process first compares neighboring candidate alignments 141 from the filter 200 output 250 for overlap and redundancy and produces a distilled list of unique potential alignment windows. Overlapping windows are combined to form a single window.

The distill hits 145 process uses the subject directory 107 to convert the hit observations 1400, recorded in units of pass number 1401, query character number 1402, filter element 1403, above gap 1404 and below gap 1405 into an alignment window 1600 within a particular subject. FIG. 16 shows the layout of an alignment window.

The alignment widow 1600 consists of a subject ID 1601, starting byte subject address 1602 within the subject polypeptide collection 106, the number of the first query character 1603 within the query polypeptide 115 and an alignment window gap width 1604 indicating the bounds for possible gapping.

The starting byte subject address 1602 is computed by subtracting the overlap factor from the number of parallel filter alignment elements 215 through 220, multiplying the result by the pass number 235, adding the element number within the filter alignments 215 through 220 where the potential alignment was recorded, and subtracting the number of contributing elements above 603. The alignment window gap width 1604 is computed by adding the number of elements above 1404 and below 1405 and one.

The distill hits process 145 passes an explore list 142 of alignment windows 1600 to the explore alignment windows process 150 which examines possible alignments of the query polypeptide 133 against each alignment widow 1600.

The computation of the score of the optimum alignment of the query polypeptide 133 within an alignment window 1600 is performed using an alignment window exploration algorithm which examines just the alignment window. This algorithm eliminates the abstractions employed by the filter by using exact similarity scores and optimum gapping locations.

In the preferred embodiment, the alignment window exploration algorithm computes only the highest score for an alignment widow, however in other embodiments, where a preponderance of lower scores can affect the statistical significance of an alignment, the algorithm may return multiple alignment scores representing multiple unique alignments within the window.

The alignment window exploration algorithm uses considerably less resources than the Smith-Waterman algorithm because it only computes the cells within the alignment width 1604 identified by the filter 200. For an example of this efficiency, consider a 50 character query aligned within a window gap width of five characters. The alignment window exploration algorithm will perform 50×5=250 calculations. A Smith-Waterman alignment would require the calculation of an entire matrix of 50 query characters by 50+5 subject characters or 50×55=2,750 calculations.

In the preferred embodiment, the alignment window exploration algorithm is implemented on a conventional CPU, but in other embodiments, it may be implemented in an FPGA, ASIC, or other logic device.

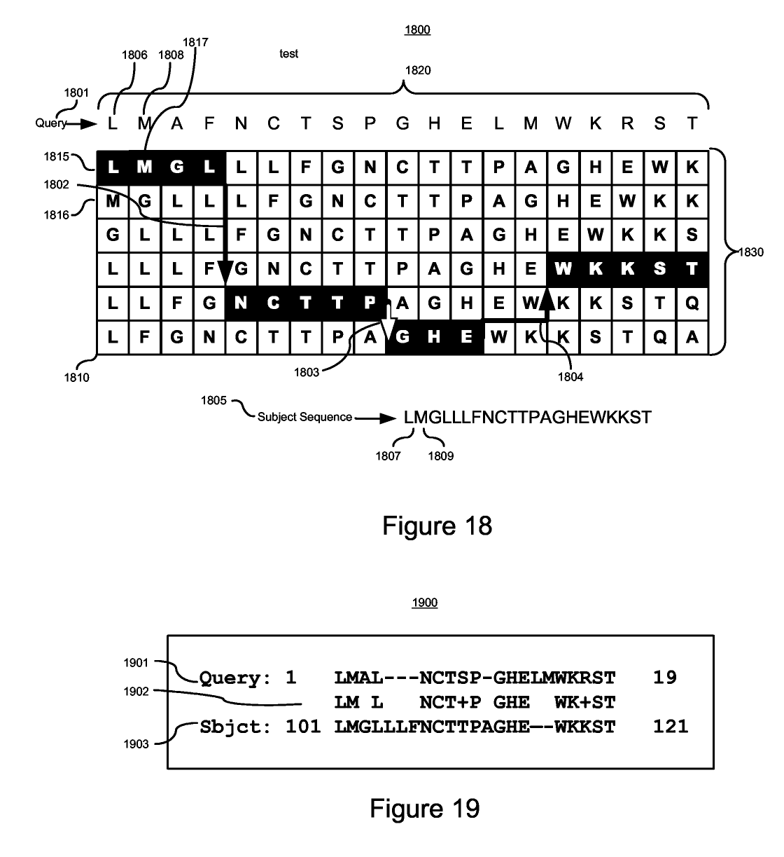

An example 1800 of an alignment of a 19 character query 1801 in a window with an alignment width 1604 of six characters is shown in FIG. 18. The alignment window exploration algorithm creates a matrix 1810 with the query length 1820 in one dimension and the alignment width 1830 in the other. Each element of the matrix 1810 corresponds to the intersection of a character of the query 1801 with a subject character 1805. The corresponding subject characters are shown in each box of the matrix 1810.

The alignment window exploration query 1801 is the portion of the query polypeptide 133 beginning with the start query character 1603. The alignment window exploration subject 1805 is the portion of the subject polypeptide 106 beginning with the start subject collection character number 1602.

The first cell of the first column 1815 of the matrix 1810 matches the first query character 1806 with the first subject character 1807. The second cell of the first column 1816 of the matrix 1810 matches the first query character 1806 with the second subject character 1809. This pattern continues with successive columns shifting the subject sequence 1805 by one character with each column. For example, the first cell of the second column 1817 compares the second character of the query 1801 with the second character 1809 of the subject sequence 1805. This results in the pattern in the matrix 1810 in which the subject character compared in a cell is reflected in the cell to its above right.

The shaded cells of the matrix 1810 represent an alignment consisting of four gapped segments.

A query gap, where a gap is inserted into the query sequence to facilitate optimum alignment, is manifested by a vertical drop in the matrix 1810. The first query gap 1802 is shown by a bold vertical arrow. A second query gap 1803 drops vertically in the same manner.

A subject gap, where a gap is inserted into the subject sequence to facilitate optimum alignment, is manifested by a diagonal rise in the matrix 1810. For each row of elevation, a query character is skipped from the alignment. A subject gap 1804 is shown by a bold rising arrow.

The alignment represented by FIG. 18 is shown in a traditional alignment representation in FIG. 19. The alignment 1900 shows the query sequence 1901 with dashes inserted to hold the place of query gap characters and a subject sequence 1903 with dashes inserted to hold the place of subject gap characters. Between these lines, a delta line 1902 echoes matching characters, displays a blank for dissimilar characters, and displays a plus sign for similar characters.

The alignment shown in FIG. 19 isn't produced by the alignment window exploration algorithm. Instead, the algorithm simply returns a maximum alignment score using the full similarity matrix specified by the similarity matrix ID 134 as an index into the similarity matrix database 131. The maximum alignment score is computed by calculating the alignment score for each cell of the matrix 1810 while capturing a maximum observed score if the alignment type 132 is local and the maximum score in the last column if the alignment type 132 is global.

To support the calculation of the maximum alignment score, each cell of the matrix 1810 contains three values 1710 shown in FIG. 17; a similarity score 1701, an alignment score 1702, and a subject gap score 1703.

The similarity score 1701 contains the matrix 1810 cell specific score for the similarity between a query amino acid corresponding to the column of the matrix 1810 and a subject amino acid. The alignment score 1702 contains the running alignment score for a cell of the matrix 1810. The subject gap score 1703 may or may not be the same as the alignment score 1702. It contains the cell's score if a subject gap is chosen.

Additionally, two values 1720 are maintained which are global to the entire matrix 1810; a query gap score 1704 and a maximum alignment score 1705.

The query gap score 1704 identifies the current alignment score if a query gap is selected. The maximum alignment score 1705 contains the greatest observed alignment score within the alignment window.

The alignment window exploration algorithm consists of an outer loop which cycles “c” from the query offset of the first query character of the alignment window 1603 through the last query character and an inner loop which cycles “r” from zero through the alignment window gap width 1604. For each occurrence within these nested loops, a subject character is selected from the subject polypeptide collection post-filter memory 106. The index “i” of the appropriate subject character is computed by summing the outer loop's “c” index, the starting byte subject address 1602, and the inner loop's “r” index.

If subject[i] contains the special null character, then the maximum alignment score 1705 is set to the maximum of the maximum alignment score 1705 and the matrix[r][c-1] alignment score. The three matrix[r][c] scores 1710 are set to zero and the next iteration of the inner loop is initiated.

Otherwise, the characters query[c] and subject[i] are used to index into a two-dimensional similarity matrix identified by the user selected similarity matrix ID 134 such as the BLOSUM 62 matrix shown in FIG. 25, where the intersection yields the matrix[r][c] similarity score 1701.

If the outer loop is on its first iteration, then the matrix[r][c] alignment score 1702 is set to the matrix[r][c] similarity score. Otherwise, the matrix[r][c] alignment score is set to the matrix[r][c-1] alignment score 1702 plus the matrix[r][c] similarity score. If the alignment type 132 is local and the newly computed matrix[r][c] value is negative, then the matrix[r][c] alignment score 1702 is set to zero.

With every cycle of the outer loop and every cycle of the inner loop where subject[c-1] is a null, the global query gap score 1704 is set to zero. Starting with the second cycle through the inner loop, the query gap score 1704 is set to the maximum of; the matrix[r-1][c] alignment score 1702 minus the open gap penalty 135 or the query gap score 1704 minus the gap extension penalty 136.

On the first and second cycle through the outer loop, i.e. for each value of r, the matrix[r][c] subject gap score 1703 is set to zero. On subsequent cycles through the outer loop, the matrix[r][c] subject gap score 1703 is set to the greater of; the matrix[r-1][c-1] subject gap score 1703 minus the matrix[r-1][c-1] similarity score 1701 minus the gap extension penalty 136, or the matrix[r-1][c-2] alignment score 1702 minus the gap extension penalty 135.

On all cycles through the outer and inner loops, the matrix[r][c] alignment score 1702 is set to the greatest of; the previously compute matrix[r][c] alignment score 1702 or the matrix[r][c] subject gap score 1703 or the matrix[r][c] query gap score 1704.

If the alignment type is local and the newly updated matrix[r][c] alignment score 1702 is greater than the maximum alignment score 1705, then the maximum alignment score 1705 is set to newly updated matrix[r][c] alignment score 1702.

After the last cycle of the outer loop, if the maximum alignment score 1705 is equal to or greater than the minimum report score computed from the e-value cutoff 137, then the maximum alignment score 1705 is captured along with the subject ID 1601 in an ordered list of the top-scoring subjects. The ordered list is limited to the user specified maximum number of scores 138 with lower scores dropped from the list to make room for higher scores.

In the preferred embodiment, all scores, including dropped ones, are counted and reported in an alignment summary. In other embodiments, a variety of statistical measurements of observed high scores may be collected.

The top subjects list 151 is passed to the create alignments process 155. In the preferred embodiment, each top-scoring subject is examined using the Smith-Waterman algorithm and all alignments with statistical significance exceeding the e-value cutoff 137 and within the maximum number of scores and alignments limits 138 are formatted into an alignment report 156 and presented to the requester. An example of such an alignment is shown in FIG. 23.

In other embodiments, the top subjects may be examined using algorithms other than Smith-Waterman and/or the alignment window information may be used to reduce the resources required to perform the post-filter examination and/or the alignments may be presented in graphical formats differing from the NCBI format shown in FIG. 23.

What is claimed is:

1. A method comprising: abstractly scoring all possible gapped and un-gapped alignments of two sequences while recording observed high-scoring alignments; rescoring the observed high-scoring alignments using precise calculations; and recording or reporting the highest of the rescored alignments.

2. The method of claim 1, wherein the two sequences comprise a subject and a query.

3. The method of claim 1, wherein the sequences are comprised of strings of characters representing amino acids.

4. The method of claim 1, wherein the length of gaps in abstractly scored alignments is limited.

5. The method of claim 1, wherein the abstract sequence alignment score is computed using a simplified similarity matrix, assigning scores for categories of degrees of match similarity.

6. The method of claim 5, wherein the categories of match similarity comprise; a) exact matches, b) similar matches, or c) dissimilar matches.

7. The method of claim 5, wherein the categories of match similarity comprise; a) exact matches, b) similar matches, c) dissimilar matches, or d) neither similar nor dissimilar matches.

8. A method comprising: scanning in its entirety, a subject collection of one or more polypeptides and identifying alignment windows within the collection of sequences which have a high probability of producing, within the alignment window, one or more statistically significant alignments with a query polypeptide.

9. The method of claim 8, wherein the similarity of a subject amino acid with a query amino acid is scored using a simplified similarity matrix, assigning scores for categories of degrees of match similarity.

10. The method of claim 9, wherein the categories of match similarity comprise; a) exact matches, b) similar matches, or c) dissimilar matches.

11. The method of claim 9, wherein the categories of match similarity comprise; a) exact matches, b) similar matches, c) dissimilar matches, or d) neither similar nor dissimilar matches.

12. The method of claim 8, wherein any number of characters from the subject collection are compared in parallel with a first character of the query polypeptide, producing a running alignment score and characteristics for each of the compared characters from the subject collection, shifting the subject characters by one character with respect to the running alignment scores and characteristics and repeating the process with the next query character until all query characters have been processed.

13. The method of claim 12, wherein each running alignment score is the maximum of; its previous running alignment score plus the similarity score derived by comparing the subject character with the query character, or a query gap score, or a subject gap score.

14. The method of claim 13, wherein the query gap score is computed from the maximum of the running alignment scores associated with the preceding subject characters minus an open gap penalty minus a gap extension penalty times the distance, in characters, between the current subject character and the subject character associated with the maximum of the running alignment scores.

15. The method of claim 14, wherein the number of preceding subject characters is limited.

16. The method of claim 14, wherein pairs of running alignment scores are compared in parallel and the maximum score is recorded along with a Boolean indicating which is the maximum, pair-maximums are compared in parallel in pairs with one another and the maximum score is recorded along with a Boolean indicating which is the maximum, quad-maximums are compared in parallel in pairs with one another and the maximum score is recorded along with a Boolean indicating which is the maximum and these values are shared among all comparisons of subject and query characters to reduce the logic required to identify the maximum running alignment scores and offset associated with preceding subject characters.

17. The method of claim 13, wherein the subject gap score is computed from the maximum of; the previous subject gap score associated with the same subject character minus a gap extension penalty and minus the similarity score associated with the same subject character and the previous query character, or the alignment score associated with the alignment of the following subject character with two query characters earlier minus an open gap penalty.

18. The method of claim 9, wherein the running alignment characteristics track the number of subject characters above and the number of subject characters below which contributed to the alignment score via a subject gap or query gap.

19. The method of claim 18, wherein the contributing query and subject characters above and below are used to compute an alignment window which identifies the bounds of a probable high scoring gapped alignment which can be later rigorously explored for optimum alignment.

20. The method of claim 12, wherein the similarity indicators associated with the current query character are selected from a similarity indicator matrix and fanned out to all subject comparisons.

21. The method of claim 12, wherein the abstract score associated with each degree of similarity is stored with each query character and fanned out to all subject comparisons.

22. The method of claim 8, wherein the subjects of the subject collection are separated by a delimiter means, such as a special null character, which is used to recognize the end of subjects, prevent alignments from extending across subject boundaries and indicate a last opportunity to record high scoring alignment windows.

23. The method of claim 8, wherein the alignment type comprises local, global or local-global.

24. The method of claim 8, wherein the scanning of the subject collection is performed in a parallel pipelined synchronous logic means.

25. The method of claim 24, wherein the synchronous logic means comprises one or more Field Programmable Gate Arrays (FPGAs), Application Specific Integrated Circuits (ASICS) or Programmable Logic Devices (PLDs).

26. A method comprising: exploring possible alignments of a query amino acid sequence within a window into a subject amino acid sequence in which an offset into the subject sequence and a maximum cumulative gap width is known, wherein an array is loaded with the subject characters identified by the alignment window, a running alignment score is computed for each character in the subject array by comparing the first query character with each subject character, incrementing to the next query character, shifting the subject character array up by one character, discarding the top character, loading the next subject character into the bottom of the array, and repeating the process until all query characters have been processed.

27. The method in claim 26, wherein the running alignment scores are computed from the maximum of the un-gapped alignment score, a query gap alignment score, and a subject gap alignment score.

28. The method in claim 27, wherein the un-gapped alignment score is computed by adding the previous running alignment score to the similarity score derived by comparing the query character with the subject character.

29. The method in claim 27, wherein the un-gapped alignment score is computed by adding the previous running alignment score to the similarity score derived by comparing the query character with the subject character, limiting the value to the maximum of the sum or zero.

30. The method in claim 27, wherein the query gap alignment score for a given element of the subject array is computed by selecting the maximum of the previous running alignment scores associated with the preceding subject characters within the subject array and subtracting an open gap penalty and additionally subtracting a gap extension penalty times the distance, in elements, between the given subject array element and the preceding maximum element in the subject array.

31. The method of claim 27, wherein the subject gap alignment score is computed from the maximum of; the previous subject gap alignment score associated with the element below in the subject array minus a gap extension penalty and minus the similarity score associated with the same subject character and the previous query character, or the running alignment score associated with the second element below of the subject array and two query characters earlier minus an open gap penalty.

32. The method of claim 26, wherein the highest alignment score observed within the alignment window is recorded along with the subject ID in an ordered list which is used to identify the subjects which have the highest scoring alignments.

33. The method of claim 26, wherein the highest alignment score observed when processing the last query character is recorded along with the subject ID in an ordered list which is used to identify the subjects which have the highest scoring alignments.

34. The method of claim 26, wherein multiple highest scores of unique alignments are recorded along with the subject ID in an ordered list grouped by subject ID which is used to identify the subjects which have the most statistically significant alignments where statistical significance is a function of all high scoring alignments within the subject.
